(19) United States
(12) Patent Application Publication
(10) Pub. No.: US 2018/0294708 A1
(43) Pub. Date: Oct. 11, 2018

(54) POWER SOURCE FOR PORTABLE ELECTRONIC DEVICE

(71) Applicant: Bryan Healey Sample, Rogersville, MO (US)

(72) Inventor: Bryan Healey Sample, Rogersville, MO (US)

(21) Appl. No.: 15/481,103

(22) Filed: Apr. 6, 2017

(51) Int. Cl. H02K 53/00; H02J 7/00; H02K 11/30

(52) U.S. Cl. CPC H02K 53/00; H02J 7/0044; H04B 1/40; H02K 2213/03; H02K 11/30

(57) ABSTRACT

A portable electronic device includes a housing, an electrical component in the housing, and a power source connected to the electrical component. The power source is configured to provide electric current to the electrical component and is located in the housing. The power source includes a filament and a resonator configured to cause the filament to vibrate at a selected frequency. The vibration of the filament generates electric current. The power source also includes a capacitor connected to the filament and configured to receive the electric current.

### FIELD

The field of the disclosure relates generally to a power source for a portable electronic device. More particularly, this disclosure relates to a self-charging power source for a portable electronic device.

### BACKGROUND

Typically, a portable electronic device includes a power source such as a battery that stores a set amount of power which is drained during operation of the portable electronic device. Accordingly, the battery and/or the portable electronic device must be regularly connected to an external power supply for charging. For example, some cellular phones may require charging at least once a day. However, at least some people rely on the portable electronic devices to perform everyday functions and charging the portable electronic device may disrupt and may even prevent people from performing some functions. Moreover, an external power supply may not be readily available when the portable electronic device requires charging.

Therefore, there is a need for a power source for a portable electronic device that provides power to the electronic device for an extended period of time without connecting to an external power supply.

### BRIEF DESCRIPTION

In one aspect, a portable electronic device includes a housing, an electrical component in the housing, and a power source connected to the electrical component. The power source is configured to provide electric current to the electrical component and is located in the housing. The power source includes a filament and a resonator configured to cause the filament to vibrate at a selected frequency. The vibration of the filament generates electric current. The power source also includes a capacitor connected to the filament and configured to receive the electric current.

In another aspect, a power source for a portable electronic device includes a resonator and a filament connected to the resonator such that the resonator causes the filament to vibrate at a selected frequency. The power source also includes a coil defining a cavity. The filament is positioned in the cavity and vibrates relative to the coil. The power source further includes a capacitor connected to the filament and configured to receive electric current when the filament vibrates. The capacitor is configured to connect to at least one electrical component of the portable electronic device and provide power to the electrical component.

In yet another aspect, a method of assembling a portable electronic device includes mounting an electrical component in a housing and positioning a power source in the housing. The power source includes a resonator, a filament connected to the resonator, and a coil defining a cavity to receive the filament. The resonator is configured to vibrate the filament relative to the coil at a selected frequency to generate electric current. The method also includes connecting the power source to the electrical component such that the power source is configured to provide power to the electrical component during operation of the portable electronic device.

### BRIEF DESCRIPTION OF THE DRAWINGS

FIG. 1 is a schematic view of a portable electronic device.

FIG. 2 is a schematic view of a power source of the portable electronic device shown in FIG. 1.

Corresponding reference characters indicate corresponding parts throughout the several views of the drawings.

### DETAILED DESCRIPTION

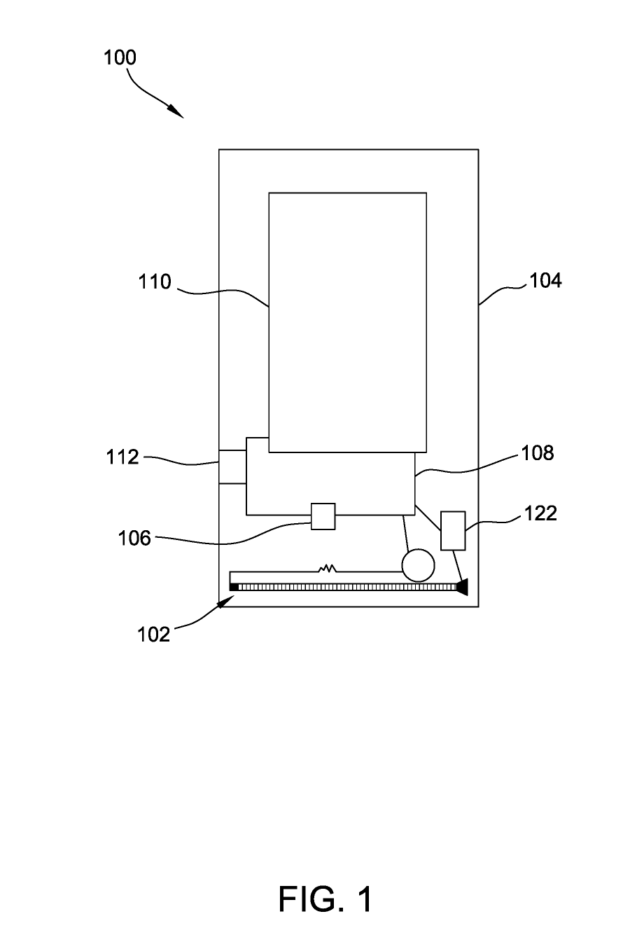

Referring now to the drawings and in particular to FIG. 1, one embodiment of a portable electronic device is designated in its entirety by the reference number 100. In suitable embodiments, the portable electronic device 100 may be any device that includes at least one electrical component. In the illustrated embodiment, the portable electronic device 100 is a portable computing device such as a cellular phone, a tablet, and/or a portable data storage device.

In the illustrated embodiment, the portable electronic device 100 includes a power source 102, a housing 104, at least one electrical component 106, an electrical circuit 108, a user interface 110, and a transceiver 112. In alternative embodiments, the portable electronic device 100 may include any suitable components that enable the portable electronic device 100 to function as described herein.

The housing 104 is configured to at least partially enclose and protect internal components of the portable electronic device 100 such as the power source 102, the electrical components 106, the electrical circuit 108, the user interface 110, and the transceiver 112. Accordingly, the housing 104 defines an interior space configured to receive the power source 102, the electrical components 106, the electrical circuit 108, the user interface 110, and the transceiver 112. In some embodiments, components such as the transceiver 112 and the user interface 110 may extend to the exterior of the housing 104. The housing 104 is constructed of resilient materials such as plastics and/or metals. In alternative embodiments, the portable electronic device 100 may include any housing 104 that enables the portable electronic device 100 to operate as described herein.

In the illustrated embodiment, the user interface 110 is configured to receive inputs from a user and to display information to the user. For example, the user interface 110 may include a touch screen. In alternative embodiments, the portable electronic device 100 may include any user interface 110 that enables the portable electronic device 100 to operate as described herein. For example, in some embodiments, the portable electronic device 100 may include, without limitation, a screen, a keyboard, a light, a speaker, a joystick, a computer mouse, a scroll ball, a microphone, a camera, a sensor, and any other suitable user interface component.

The transceiver 112 is configured to exchange signals with at least one other electronic device. For example, the transceiver 112 may enable the portable electronic device 100 to communicate using one or more wireless communication systems. The transceiver 112 may utilize electromagnetic waves and/or any suitable communication signal. In some embodiments, the portable electronic device 100 may communicate through a wired connection in addition to and/or in place of a wireless connection. In alternative embodiments, the portable electronic device 100 may include any communication component that enables the portable electronic device 100 to operate as described herein. In some embodiments, the transceiver 112 may be omitted or selectively turned off and the portable electronic device 100 may be configured to not communicate with other devices, i.e., the portable electronic device 100 may operate “off the grid.”

In addition, the power source 102 is sized to fit within the housing 104. In particular, in the illustrated embodiment, the power source 102 is completely enclosed in the housing 104. In some embodiments, a component of the power source 102, such as an input/output connector, may extend to the exterior of the housing 104. The power source 102 allows the portable electronic device 100 to have a compact and portable configuration because the power source 102 is within the housing 104. In addition, the power source 102 is integrated into the portable electronic device 100 and reduces the number of parts required to assemble and operate the portable electronic device 100. In alternative embodiments, the power source 102 may be removable from other components of the portable electronic device 100. In further embodiments, the power source 102 may be positioned in a second housing (not shown) that is positioned within and/or attached to the housing 104. For example, in some embodiments, the power source 102 may include a housing shaped similar to a standardized battery and the power source 102 may be configured to replace the battery.

In the illustrated embodiment, the circuit 108 extends between and connects the power source 102, the electrical component 106, the user interface 110 and the transceiver 112. The power source 102 supplies electric current through the circuit 108 to the electrical component 106, the user interface 110, and/or the transceiver 112. In alternative embodiments, the portable electronic device 100 may include any circuit 108 that enables the portable electronic device to operate as described herein.

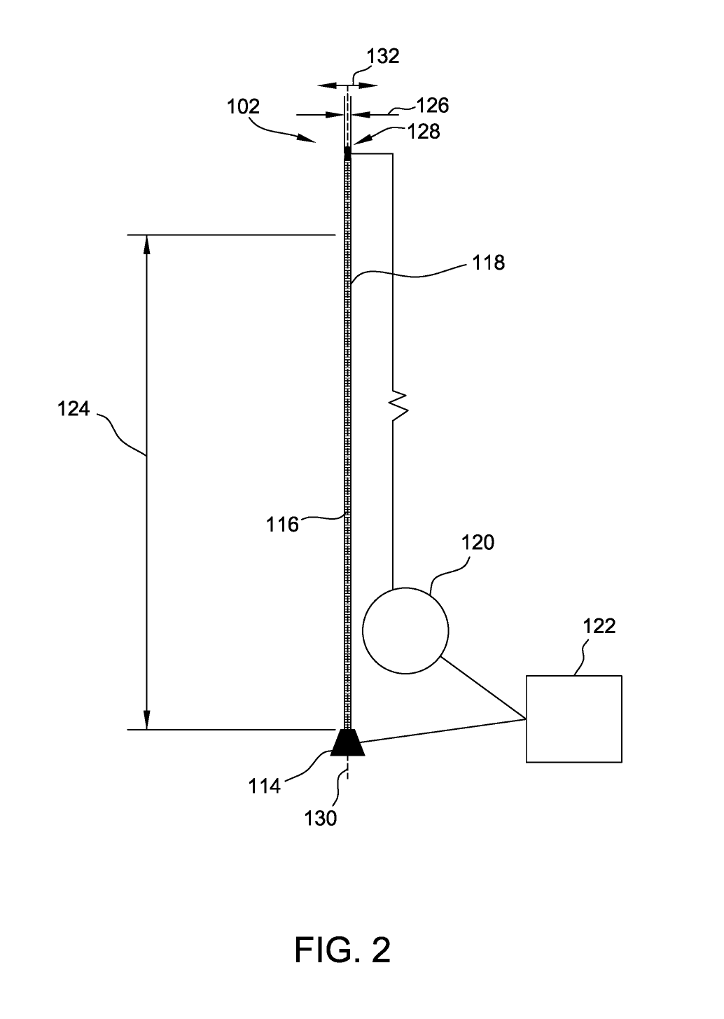

As shown in FIG. 2, the power source 102 includes a resonator 114, a filament 116, a coil 118, a capacitor 120, and a controller or governor 122. In alternative embodiments, the power source 102 may include any component that enables the power source 102 to operate as described herein.

During operation of the power source 102, the resonator 114 receives power from the capacitor 120 and causes the filament 116 to vibrate. The resonator 114 may be sized to allow the power source 102 to fit within the housing 104. For example, in some embodiments, the resonator 114 may have a length, a width, and a depth that are each about 1 centimeter or less. In the illustrated embodiment, the resonator 114 has a length of about 1 centimeter, a width of about 1 centimeter, and a depth of about 4 millimeters. In alternative embodiments, the power source 102 may include any resonator 114 that enables the power source 102 to operate as described herein.

In the illustrated embodiment, the filament 116 is connected to the resonator 114 such that the resonator 114 causes the filament 116 to vibrate. Specifically, the resonator 114 is configured to vibrate the filament 116 at a selected, resonant frequency. For example, a contact of the resonator 114 may periodically contact the filament 116 and causes the filament 116 to vibrate. The filament 116 may continue to vibrate, i.e., resonate, after the contact has contacted the filament 116. As a result, the energy required to vibrate the filament 116 is reduced. In alternative embodiments, the resonator 114 may cause the filament 116 to vibrate in any manner that enables the power source 102 to function as described herein.

In addition, in the illustrated embodiment, the filament 116 includes a strip of metal such as iron. In alternative embodiments, the filament 116 may include any material that enables the power source 102 to operate as described herein.

As shown in FIG. 2, the filament 116 has a length 124 along a longitudinal axis 130. In some embodiments, the length 124 may be in a range of about 0.25 inches (in.) to about 5 in. In the illustrated embodiment, the filament 116 has a length 124 of approximately 1 in. The filament 116 has a thickness 126. In some embodiments, the thickness 126 is in a range of about 1 micron to about 20 microns. In alternative embodiments, the filament 116 may be any size that enables the power source 102 to operate as described herein.

The coil or dynamo 118 is helical and defines a cavity 128. The filament 116 is positioned in the cavity 128 and vibrates relative to the coil 118 in a direction 132 perpendicular to the longitudinal axis 130. Vibration of the filament 116 within the coil 118 generates an electric current in the filament 116. The coil 118 may be any suitable material. In this embodiment, the coil 118 is a metal such as copper. In alternative embodiments, the power source 102 includes any coil 118 that enables the power source 102 to operate as described herein.

The coil 118 and the filament 116 are sized to facilitate the power source 102 generating electric current when the filament 116 vibrates. In some embodiments, a ratio of a length of the coil 118 to the length 124 of the filament 116 may be in a range of about 1 to about 2. In the illustrated embodiment, the ratio of a length of the coil 118 to the length 124 of the filament 116 is approximately 1.3. In addition, a ratio of the diameter of the cavity to the thickness 126 may be in a range of about 1.5 to about 5. In the illustrated embodiment, the ratio of the diameter of the cavity to the thickness 126 is approximately 2.

The capacitor 120 is connected to the filament 116 and configured to receive electric current when the filament 116 vibrates. In addition, the capacitor 120 is configured to store power. Accordingly, the electric current provided by the filament 116 may charge the capacitor 120, i.e., the filament 116 may increase the power stored in the capacitor 120. In the illustrated embodiment, the capacitor 120 may be constructed of carbon nanotubes and may have a storage capacity of at least about 150 milliamp hours. In alternative embodiments, the power source 102 may include any capacitor 120 that enables the power source 102 to operate as described herein.

Suitably, the capacitor 120 may be initially charged by an external power supply (not shown) to provide a minimum charge for operation of the resonator 114. In addition, the capacitor 120 may be charged after an extended period of time to prevent the power level of the capacitor 120 from dropping below the minimum charge. Between charges, operation of the power source 102 maintains the power level of the capacitor 120 at a desired level, i.e., power source 102 tops off the capacitor 120. As a result, the power source 102 is not required to maintain the power level of the capacitor 120 indefinitely. Rather, the power source 102 maintains a sufficient power level in the capacitor 120 for an extended period of time and reduces the frequency that the capacitor 120 needs to be charged. For example, the power source 102 may enable the portable electronic device 100 (shown in FIG. 1) to operate for weeks, months, or even longer, without charging.

The resonator 114 may be configured to vibrate at any suitable frequency. In the illustrated embodiment, the resonator 114 vibrates at a resonant frequency that is configured to increase the electric current generated from the vibrations of the filament 116. In some embodiments, the vibrations of the filament 116 may be varied by the controller 122 based on power requirements of the power source 102 and/or the portable electronic device 100.

The controller 122 is connected to the resonator 114 and configured to regulate electric current provided to the capacitor 120. Specifically, the controller 122 may be configured to determine a power level of the capacitor 120 and cause the filament 116 to vibrate and/or increase vibrations of the filament 116 if the power level is below a lower threshold value. The controller 122 may be configured to stop or slow vibration of the filament 116 once the power level of the capacitor 120 exceeds an upper threshold value. Accordingly, the controller 122 allows the capacitor to be maintained within a predetermined range. In addition, the controller 122 may be configured to adjust, i.e., increase and decrease, vibration of the resonator 114 based on power usage of the portable electronic device 100 (shown in FIG. 1). In alternative embodiments, the power source 102 may include any controller 122 that enables the power source to operate as described herein. In some embodiments, the controller 122 may be integrated into a controller of the portable electronic device 100 (shown in FIG. 1).

The resonator 114 may require a minimum charge of the capacitor 120 to vibrate. Accordingly, if the charge of the capacitor 120 drops below the minimum charge the power source 102 may not operate normally. Accordingly, the power source 102 may need to be charged occasionally to maintain the power level above the minimum charge depending on the usage of the portable electronic device 100.

In reference to FIG. 1, in some embodiments, the controller 122 may send a signal when the power level of the capacitor 120 drops below a minimum threshold to prevent the capacitor dropping below the minimum charge. In further embodiments, the controller 122 may cause the portable electronic device 100 to operate in a manner to use less energy, i.e., a power saving mode. For example, the controller 122 may restrict operation of some functions of the portable electronic device 100 in the power saving mode. In further embodiments, the controller 122 may cause the portable electronic device 100 to shut down or suspend operation for a period of time until the power source 102 increases the charge of the capacitor 120. Accordingly, the controller 122 may reduce or eliminate the need to charge the power source 102 after the power source 102 has received an initial charge.

The power source described herein is self-charging and provides power to a portable electronic device without connecting to an external power supply for an extended period of time. For example, embodiments of the power source include a resonator that connects to a capacitor and provides power to the capacitor to maintain a consistent charge of the capacitor. The capacitor provides power to at least one electrical component of the portable electronic device. In some embodiments, the power source is integrated into the portable electronic device. In addition, the power source may have a longer expected life than at least some known power sources and batteries for portable electronic devices. As a result, the portable electronic devices described herein can be powered for a longer period of time and have an extended service life.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawings shall be interpreted as illustrative and not in a limiting sense. Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A portable electronic device comprising:
a housing;
an electrical component in the housing; and
a power source connected to the electrical component and configured to provide electric current to the electrical component, wherein said power source is located in the housing, said power source comprising:
a filament;
a resonator configured to cause the filament to vibrate at a selected frequency, wherein vibration of the filament generates electric current; and
a capacitor connected to the filament and configured to receive the electric current, wherein the capacitor is connected to the electrical component and configured to provide electric current to the electrical component.

2. The portable electronic device of claim 1 further comprising a user interface configured to receive inputs from a user and to display information to the user, wherein the user interface is connected to the power source and configured to receive power from the power source.

3. The portable electronic device of claim 1 further comprising a transceiver connected to the power source and configured to receive power from the power source.

4. The portable electronic device of claim 1 further comprising a controller connected to the resonator and configured to regulate electric current provided to the capacitor.

5. The portable electronic device of claim 4, wherein the controller is configured to determine a power level of the capacitor and cause the resonator to vibrate if the power level is below a threshold value.

6. The portable electronic device in accordance with claim 1 further comprising a coil defining a cavity, wherein the filament is positioned in the cavity and vibrates relative to the coil.

7. The portable electronic device of claim 6, wherein the filament has a length in a range of about 0.25 inches (in.) to about 5 in.

8. The portable electronic device of claim 7, wherein a ratio of a length of the coil to the length of the filament is in a range of about 1 to about 2.

9. A power source for a portable electronic device, the power source comprising:
a resonator;
a filament connected to the resonator such that the resonator causes the filament to vibrate at a selected frequency;
a coil defining a cavity, wherein the filament is positioned in the cavity and vibrates relative to the coil; and
a capacitor connected to the filament and configured to receive electric current when the filament vibrates, wherein the capacitor is configured to connect to at least one electrical component of the portable electronic device and provide power to the electrical component.

10. The power source of claim 9 further comprising a controller connected to the resonator and configured to regulate electric current provided to the capacitor.

11. The power source of claim 10, wherein the controller is configured to determine a power level of the capacitor and cause the resonator to vibrate if the power level is below a threshold value.

12. The power source of claim 9, wherein the filament has a length in a range of about 0.25 inches (in.) to about 5 in.

13. The power source of claim 12, wherein a ratio of a length of the coil to the length of the filament is in a range of about 1 to about 2.

14. The power source of claim 9, wherein said power source is sized to fit within a housing of the portable electronic device.

15. The power source of claim 9, wherein the capacitor is connected to the resonator and configured to provide power to the resonator.

16. A method of assembling a portable electronic device, the method comprising:
mounting an electrical component in a housing;
positioning a power source in the housing, wherein the power source includes a resonator, a filament connected to the resonator, and a coil defining a cavity to receive the filament, wherein the resonator is configured to vibrate the filament relative to the coil at a selected frequency to generate electric current; and
connecting the power source to the electrical component such that the power source is configured to provide power to the electrical component during operation of the portable electronic device.

17. The method of claim 16 further comprising connecting a capacitor to the filament such that the capacitor receives the electric current when the filament vibrates.

18. The method of claim 17 further comprising connecting a controller to the resonator, wherein the controller is configured to regulate electric current provided to the capacitor.

19. The method of claim 16 further comprising connecting a user interface to the power source such that the user interface is configured to receive power from the power source.

20. The method of claim 16 further comprising connecting a transceiver to the power source such that the transceiver is configured to receive power from the power source.
